(19) United States
(12) Patent Application Publication
(10) Pub. No.: US 2005/0236021 A1
(43) Pub. Date: Oct. 27, 2005

(54) Self-propelled cleaner

(75) Inventor: Kazuaki Suzuki, Osaka (JP)

Correspondence Address: Yokoi & Co., U.S.A., Inc., 13700 Marina Pointe Drive #1512, Marina Del Rey, CA, 90292, US

(73) Assignee: Funai Electric Co., Ltd., Osaka (JP)

(21) Appl. No.: 11/102,968

(22) Filed: Apr. 11, 2005

(30) Foreign Application Priority Data
Apr. 15, 2004 (JP) JP2004-120581

(51) Int. Cl. B08B 3/00

(52) U.S. Cl. 134/56 R; 134/113; 134/172; 134/198

(57) ABSTRACT

Conventionally, it is impossible to water a potted plant or the like with a freely moving cleaner. A cleaner of this invention finds a travel route to the location of a first potted plant said cleaner determines that current time is a timer-set time, travels to said location to pour a specified amount of water on said potted plant, on completion of that watering finds a travel route to a second potted plant, travels to said location, pours a specified amount of water on said second potted plant, and on completion of that watering returns to an initial standby position at a hall.

### BACKGROUND OF THE INVENTION

1. Field of the Invention

This invention relates to a self-propelled cleaner comprising a body containing a cleaning mechanism and a drive mechanism capable of steering and driving the cleaner.

2. Description of the Prior Art

The following patent documents are disclosed on the robots that sprinkles water on plants periodically:
Patent document 1: Japanese Translation of Unexamined PCT Appln. No. 2003-515210
Patent document 2: Japanese Patent Laid-Open No. H6-133645
Patent document 3: Japanese Patent Laid-Open No. H6-315327

The patent document 1 refers to a function that sprinkles water on dried areas of a land.

The patent document 2 discloses a robot that is equipped with a traveling mechanism and reads the information from a data carrier facing it.

The patent document 3 discloses a technology for sprinkling water while moving on rails.

The patent document 1 refers to a water sprinkling function (paragraph 0233) but does not describe its construction, and therefore it is not disclosed in effect.

The patent document 2 discloses a robot that is mounted with a traveling mechanism and reads the information from a data carrier facing it but does not disclose a traveling control that is most difficult technologically, and therefore it is nothing but a so-called description of a desire.

The patent document 3 discloses a technology for sprinkling water while moving on rails and its moving capability is realizable but this technology cannot be used at places with no rail installed.

### SUMMARY OF THE INVENTION

This invention has been made in view of the above mentioned problems with the prior arts and an object of the invention is to provide a self-propelled cleaner that is capable of traveling by itself and can also be used for watering a potted plant and the like.

The self-propelled cleaner according to this invention comprises a body containing a cleaning mechanism; a drive mechanism capable of steering and driving the cleaner; a mapping processor storing map information on a room to be cleaned; a watering mechanism to water a potted plant located at predetermined place and height; and a watering control processor that controls at a predetermined timing said drive mechanism based on the location of a potted plant set in said map information to thereby move the cleaner from the present location to the predetermined location and cause said watering mechanism to water.

A cleaner of this invention that is constructed as above has a drive mechanism capable of steering and driving the cleaner as mentioned above and thus it is possible for the cleaner to travel by itself for cleaning. Furthermore, the mapping processor stores geographical information on a room to be cleaned and the watering control processor controls at a predetermined timing said drive mechanism based on the location of a potted plant set in said map information to thereby causes the cleaner to travel from present location to the location of potted plants and then causes the watering mechanism to water the potted plant located at predetermined place and height.

That is, giving positional information on a potted plant to a cleaner with an inherent self-propelling capability enables the cleaner to travel and water the plant.

A self-propelled cleaner travels around a room to obtain geographical information on the room but it is laborious to give positional information on a potted plant externally. In an embodiment of this invention, therefore, said mapping processor obtains said positional information from a marker that is installed at a predetermined location in the room and outputs predetermined positional information, and adds that positional information to the geographical information.

If constructed as described above, the mapping processor obtains and adds positional information to the geographical information by installing the marker, which outputs a predetermined positional information, at a predetermined location at which the user wishes to set said predetermined positional information.

For example, it is possible to set the location of a potted plant as a predetermined location. It is also possible to set multiple locations corresponding to multiple potted plants as predetermined locations.

The self-propelled cleaner can generate the mapping information in various ways but providing a user with an interface for the user to be able to view the geographical information will require displaying the map, accepting an input from user's operation, and the like, which will be costly and laborious. In addition, while the self-propelled cleaner is generating geographical information the cleaner is not necessarily traveling at the time and place the user wishes, thus making it impossible to always accept user' operation when the cleaner reaches the desired position. In contrast, positional information can be set very easily simply by installing the marker that can provide required information.

A watering mechanism can be constructed in various ways. As an example, said watering mechanism comprises a reverse-J shaped watering nozzle that can be tilted vertically at its base and a lift mechanism that supports said watering nozzle from below at the point nearer to the end of said watering nozzle than its turning fulcrum at the base of the nozzle and can move up and down, said lift mechanism moving up before watering and down when watering starts.

Said lift mechanism according to this invention moves up before watering. Since the lift mechanism supports said watering nozzle from below at the point to the end of the nozzle than its turning fulcrum at the base of the nozzle, when the lift mechanism moves up the end of the nozzle, tilts vertically upward by itself and thus the reverse-J shaped end of the nozzle reaches its highest position, which is higher than the top of the potted plant. Needless to say, potted plants higher than this highest position is not covered.

As the lift mechanism lowers to start watering, the watering nozzle lowers toward the potted plant. At this time, since the lift mechanism supports the nozzle only from below, the nozzle lowers only with its own weight and therefore stops when the nozzle hits the plant or soil in the pot.

This allows for watering each potted plant at an optimum height, eliminating the possibility of watering from far above a potted plant and spilling water around the pot.

As an example of a watering mechanism, said watering mechanism has a water supply tank with an opening and a lid on its top, which is used in conjunction with a predetermined water supply station. Said water supply station has an alignment mechanism capable of aligning a water supply nozzle with the opening of said water supply tank. Said watering mechanism is so constructed as to open said lid at the position of said water supply station and receive water.

If constructed as described above, the alignment mechanism provided to the water supply station aligns the water supply nozzle of the water supply station with the opening of the water supply tank having the opening and the lid, and said watering mechanism opens the lid at the position of the watering station and receives water through the water supply nozzle.

As a cleaner contains more water a more powerful drive mechanism is required, which increases the cost of the cleaner. However, since the water supply station allows the water supply nozzle to be automatically aligned with the water supply tank having the opening on its top for supplying water through the opening, it is possible to replenish the water in the water supply tank as needed and consequently the amount of water to be held in the water supply tank can be reduced, making it unnecessary to provide a needlessly powerful drive mechanism.

As an example of a watering mechanism, said watering mechanism comprises a pump to pressurize the water for discharging and a magnetic valve to control the amount of water by discharging pressurized water for a predetermined duration, whereby the duration of opening said magnetic valve can be adjusted to adjust the amount of discharging water.

If constructed as described above, water pressure is made constant by the pump and thus the amount of discharging water per hour can be determined, which makes it possible to adjust the amount of water by adjusting the duration of opening the magnetic valve.

The amount of water to be discharged can be given together with positional information and it is also possible to give a staged amount of water, such as “large, medium, small”, instead of a specific amount.

As for the cleaning mechanism provided to the body, any of a suction-typed, brush-typed, or combination-typed cleaning mechanism can be adopted.

For the drive mechanism capable of steering and driving the cleaner, it is possible to steer and drive the cleaner in the forward, backward, right, or left direction, or to turn the cleaner at the same place by controlling individually drive wheels provided at the right and left sides of the body. In this case, auxiliary wheels may be provided, for example, before and behind the drive wheels. Furthermore, the drive wheels can be so constructed as to drive endless belts as well as wheels. Besides these, a drive mechanism with four wheels, six wheels, or the like can also be realized.

As an example of a more specific construction based on the above construction, this invention is a self-propelled cleaner comprising a body with a cleaning mechanism and a driving mechanism having drive wheels that are provided at the right and left sides of the body and can be individually controlled to steer and drive the cleaner. The cleaner obtains and stores geographical information on a room being cleaned while traveling around the room and at the same time obtains positional information of a potted plant from a marker that is installed at a predetermined location in the room and outputs predetermined positional information. Furthermore, the cleaner is equipped with a mapping processor providing additional positional information to said geographical information; a reverse-J shaped watering nozzle that can be tilted vertically at its base; and a lift mechanism that supports said watering nozzle from below at a point nearer to the end than the turning fulcrum of the nozzle at its base and can move up and down. Said lift mechanism moves up before watering and down when watering starts and is equipped with a pump to pressurize discharging water to a predetermined pressure and a magnetic valve to control the amount of discharging water by discharging pressurized water for a predetermined duration, and it is possible to adjust the amount of discharging water by adjusting the duration of opening said magnetic valve. The cleaner is further equipped with a water supply tank with an opening and a lid on its top; a watering mechanism that receives water from the tank by opening the lid at a predetermined position of a water supply station and water a potted plant located at a predetermined place and height; and a watering control processor capable of controlling said drive mechanism to move the cleaner from present position to the position of the potted plant based on said position of the plant to be set in said geographical information at a predetermined timing and then cause said watering mechanism to discharge water.

By constructing the cleaner as described above, the mapping processor obtains and stores geographical information of a room while traveling around the room for cleaning and also obtains positional information on a potted plant from the marker that is installed at a predetermined location in the room and outputs a predetermined positional information, and adds that information to said geographical information. The watering control processor controls said drive mechanism to move the cleaner from present position to a predetermined position based on the position of the potted plant to be set in said geographical information at a predetermined timing and then cause the watering mechanism to water the potted plant located at a predetermined place and height.

The lift mechanism moves up to the watering mechanism before discharging water. Since the lift mechanism supports the watering nozzle from below at a point nearer to the end of the nozzle than the turning fulcrum at its base, as the lift mechanism moves up, the end of the nozzle tilts vertically upward and the reverse-J shaped end of the nozzle is at the highest position which is higher than the top of the potted plant. Needless to say, potted plants higher than this highest position are not covered for watering.

As the lift mechanism lowers to start watering, the watering nozzle lowers toward the potted plant. At this time, since the lift mechanism supports the watering nozzle only from below the nozzle, the nozzle moves down only with its own weight and therefore stops lowering when the nozzle hits the plant or soil in the pot and discharges water in this position. The alignment mechanism of the water supply station aligns the water supply nozzle with the opening of the water supply tank having the opening and lid on its top. The watering mechanism opens said lid at the position of the watering station and receives water through the water supply nozzle. Furthermore, since water pressure is made constant by the pump and thus the amount of discharging water per hour is determined, which allows the amount of water to be adjusted by adjusting the opening duration of the magnetic valve.

Thus, the cleaner of this invention is easy to move to the location of a potted plant taking advantage of its self-propelling feature and it is possible to realize the capability of watering potted plants without additional mechanisms.

### BRIEF DESCRIPTION OF THE DRAWINGS

FIG. 1 is a block diagram showing the schematic construction of a self-propelled cleaner according to this invention.

FIG. 2 is a more detailed block diagram of said self-propelled cleaner.

FIG. 3 is a block diagram of a passive sensor for AF.

FIG. 4 is an explanatory diagram showing the position of a floor relative to the passive sensor and how ranging distance changes when the passive sensor for AF is oriented obliquely toward the floor.

FIG. 5 is an explanatory diagram showing the ranging distance for imaging range when a passive sensor for AF for adjacent area is oriented obliquely toward a floor.

FIG. 6 is a diagram showing the positions and ranging distances of individual passive sensors for AF.

FIG. 7 is a flowchart showing a traveling control.

FIG. 8 is a flowchart showing a traveling for cleaning.

FIG. 9 is a diagram showing a traveling route in a room.

FIG. 10 is a diagram showing the construction of an optional unit.

FIG. 11 is a diagram showing the external appearance of a marker.

FIG. 12 is a flowchart showing mapping processing.

FIG. 13 is a diagram illustrating a mapping.

FIG. 14 is a diagram illustrating how the geographical information on each room is linked together after mapping.

FIG. 15 is a schematic side view of a watering mechanism.

FIG. 16 is a schematic top view of said watering mechanism.

FIG. 17 is a diagram showing a screen for setting traveling times, potted plants to be watered, and amount of discharging water.

FIG. 18 is a flowchart showing a traveling and watering process.

FIG. 19 is a top view of rooms showing a traveling route through them.

### DESCRIPTION OF THE PREFERRED EMBODIMENTS

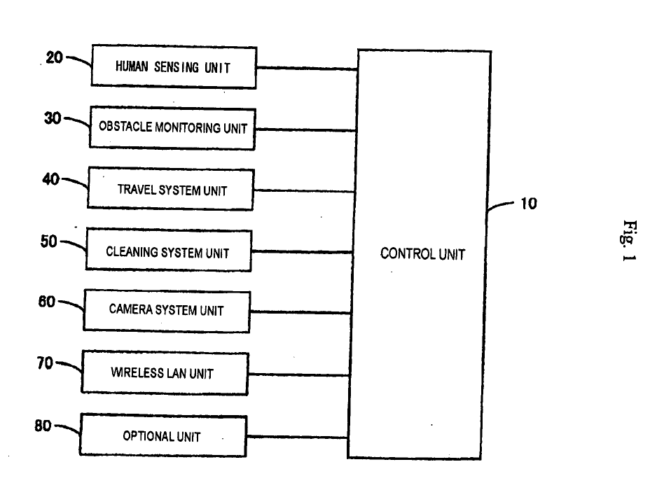

FIG. 1 is a block diagram showing the schematic construction of a self-propelled cleaning according to this invention. As shown in the figure, the cleaner comprises a control unit 10 to control individual units; a human sensing unit 20 to detect a human or humans around the cleaner; an obstacle detecting unit 30 to detect an obstacle or obstacles around the cleaner; a traveling system unit 40 for traveling; a cleaning system unit 50 to perform a cleaning; a camera system unit 60 to take an image of a predetermine range; a wireless LAN unit 70 for wireless connection to a LAN; and an optional unit 80 including additional sensors and the like. The body of the cleaner has a flat rough cylindrical shape.

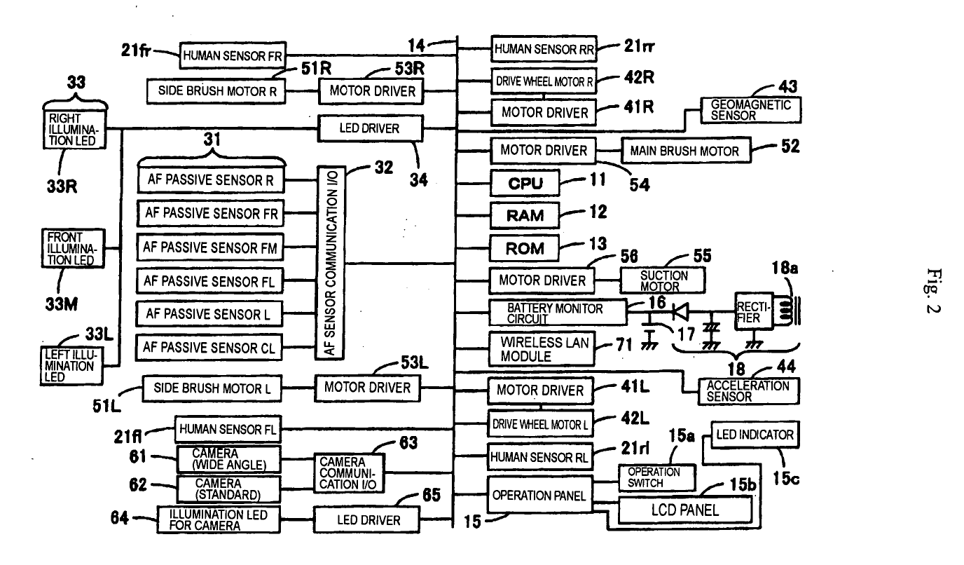

FIG. 2 is a block diagram showing the construction of an electric system that realizes the individual units concretely. A CPU 11, a ROM 13, and a RAM 12 are interconnected via a bus 14 to form the control unit 10. The CPU 11 performs various controls using the RAM 12 as a work area according to a control program stored in the ROM 13 and various parameter tables. The contents of said control program will be described later in detail.

The bus 14 is equipped with an operation panel 15 on which various types of operation switches 15a, an LED display panel 15b, and LED indicators 15c are provided. Although a monochrome LED panel capable of multi-tone display is used for the LED display panel, a color LED panel or the like can also be used.

This self-propelled cleaner has a battery 17 and allows the CPU 11 to monitor the remaining amount of the battery 17 through a battery monitor circuit 16. Said battery 17 is equipped with a charge circuit 18 that charges the battery with an electric power supplied non-contact through an induction coil 18a. The battery monitor circuit 16 mainly monitors the voltage of the battery 17 to detect its remaining amount.

The human sensing unit 20 consists of four human sensors 21 (21fr, 21rr, 21f1, 21r1), two of which are disposed obliquely at the left and right sides of the front of the body and the other two at the left and right sides of the rear of the body. Each human sensor 21 has a light-receiving sensor that detects the presence of a human based on the amount of infrared light received. In order to change the status for output when the human sensor detects a moving object to which an infrared light is radiated, the CPU 11 can obtain detection status of the human sensor 21 via the bus 14. That is, the CPU 11 is allowed to obtain the status of each of the human sensors 21fr, 21rr, 21f1, and 21r1 at predetermined intervals and detect the presence of a human in front of the human sensor 21fr, 21rr, 21f1, or 21rl if the status changes.

Although the human sensor described above detects the presence of a human based on changes in the amount of infrared light, an embodiment of the human sensor is not limited to this. For example, if the CPU's processing capability is increased, it is possible to take a color image of the room to identify a skin-colored area that is characteristic of a human and detect the presence of a human based on the size of the area and/or changes in the area.

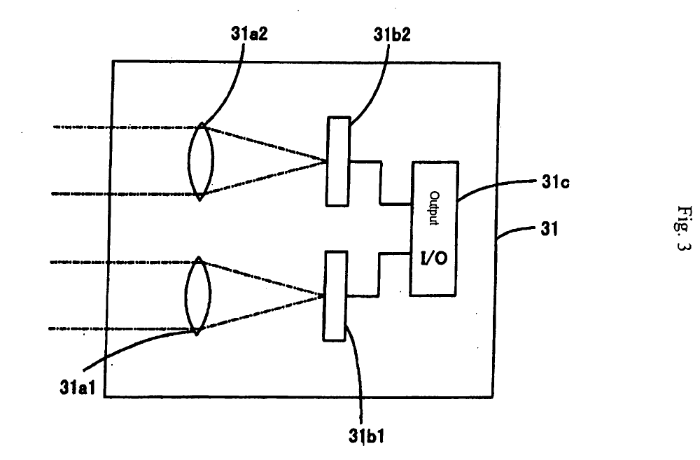

The obstacle monitoring unit 30 comprises the passive sensor 31 (31R, 31FR, 31FM, 31FL, 31L, 31CL) as a ranging sensor for auto focus (hereinafter, called AF); an AF sensor communication I/O 32 as a communication interface to the passive sensor 31; an illumination LED 33; and an LED driver 34 to supply a driving current to each LED. First, the construction of the passive sensor for AF 31 will be described. FIG. 3 shows a schematic construction of the passive sensor for AF 31 comprising almost parallel biaxial optical systems 31a1, 31a2; CCD line sensors 31b1, 31b2 disposed approximately at the image focus locations of said optical systems 31a1 and 31a2 respectively; and an output I/O 31c to output image data taken by each of the CCD line sensors 31b1 and 31b2.

The CCD line sensors 31b1, 31b2 has a CCD sensor with 160 to 170 pixels and can output 8-bit data representing the amount of light for each pixel. Since the optical system is biaxial, formed images are misaligned according to the distances, which enables the distance to be measured based on a disagreement between data output from respective CCD line sensors 31b1 and 31b2. For example, the smaller the distance the larger the misalignment of a formed image and vice versa. Therefore, an actual distance is determined by scanning data row for each four to five pixels in output data, finding a difference between the address of an original data row and that of a discovered data row, and then referencing a “difference to distance conversion table” prepared in advance.

Out of the passive sensors for AF 31R, 31FR, 31FM, 31FL, 31L, and 31CL, the 31FR, 31FM, 31FL are used to detect an obstacle located straight ahead of the cleaner, the 31R, 31L are for detecting an obstacle located immediately ahead of the left or right side of the cleaner, and the 31CL is for detecting a distance to the forward ceiling.

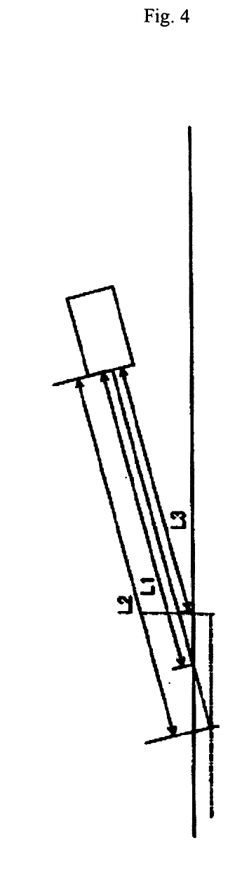

FIG. 4 shows the principle of detecting an obstacle located straight ahead of the cleaner or immediately ahead of the left or right side of the cleaner by means of the passive sensors for AF 31. These passive sensors are mounted obliquely toward a forward floor. If there is no obstacle ahead, ranging distance of the passive sensor for AF 31 is L1 in almost whole image pick-up range. However, if there is a step as shown with a dotted line in the Figure ranging distance becomes L2, thus making it possible to determine that there is a downward step if ranging distance extends. Likewise, if there is an upward step as shown with a double-dashed line ranging distance becomes L3. Ranging distance for an obstacle also becomes a distance to the obstacle as in the case of an upward step and thus becomes shorter than a distance to floor.

In this embodiment, if the passive sensor for AF 31 is mounted obliquely toward a forward floor, its image pick-up range becomes about 10 cm. Since the self-propelled cleaner is 30 cm in width, three passive sensors for AF 31FR, 31FM, 31FL are mounted at slightly different angles from each other so that their image pick-up ranges will not overlap. This allows the three passive sensors for AF to detect any obstacle or step within a forward 30 cm range. Need less to say, detection range varies with the specification and/or mounting position of a sensor, in which case the number of sensors meeting actual detection range requirements may be used.

The passive sensors for AF 31R, 31L which detect an obstacle located immediately ahead of the right and left sides of the cleaner are mounted obliquely toward a floor relative to vertical direction. The passive sensor for AF 31R disposed at the left side of the body faces opposite direction so as to pick up an image of the area immediately ahead of the right side of the body and to the right across the body. The passive sensor for AF 31L disposed at the right side of the body also faces the opposite direction so as to pick up an image of the area immediately ahead of the left side of the body and to the left across the body.

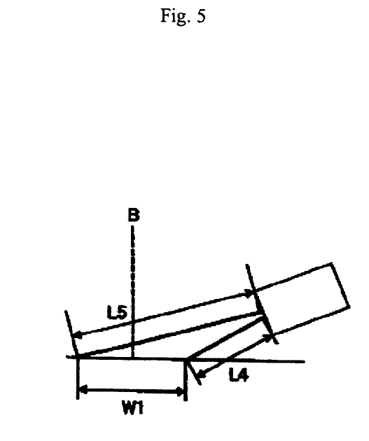

If said two sensors are disposed so that each sensor picks up an image of the area immediately ahead of it, the sensor must be mounted so as to face a floor at a steep angle and consequently the image pick-up range becomes narrower, thus making it necessary to provide multiple sensors. To prevent this, the sensors are intentionally disposed cross-directionally to widen the image pick-up range so that required range can be covered by as few sensors as possible. Meanwhile, mounting the sensor obliquely toward a floor relative to the vertical direction means that the arrangement of CCD line sensors is vertically directed and thus the width of an image pick-up range becomes W1 as shown in FIG. 5. Here, distance to the floor is short (L4) on the right of the image pick-up range and long (L5) on the left. If the border line of the side of the body is at the position of the dotted line B, an image pick-up range up to the border line is used for detecting a step or the like and an image pick-up range beyond the border line is used for detecting a wall.

The passive sensor for AF 31CL to detect a distance to a forward ceiling faces the ceiling. The distance between the floor and ceiling to be detected by the passive sensor 31CL is normally constant. However, as the cleaner approaches a wall, the wall, not the ceiling, becomes the image pick-up range and consequently a ranging distance gets shorter, allowing a more precise detection of a forward wall.

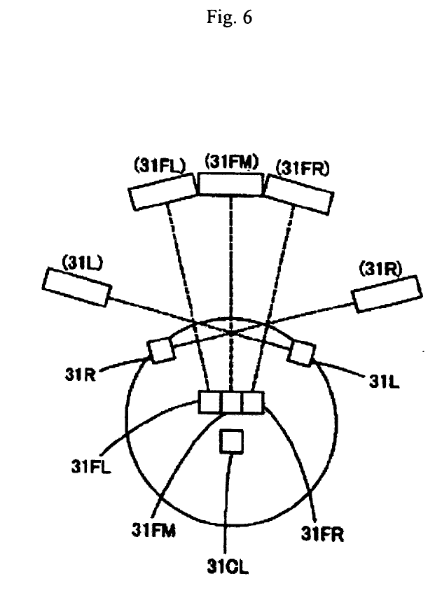

FIG. 6 shows the positions of the passive sensors for AF 31R, 31FR, 31FM, 31FL, 31L, 31CL mounted on the body and their corresponding image pick-up ranges in parentheses. The image pick-up ranges for a ceiling are not shown.

A right illumination LED 33R, a left illumination LED 33L, and a front LED, all of which are white LED, are provided to illuminate the image pick-up ranges of the passive sensors for AF 31R, 31FR, 31FM, 31FL, 31L. An LED driver 34 supplies drive current to turn on these LEDs according to a control command from the CPU 11. This allows obtaining effective pick-up image data from the passive sensors for AF 31 even at night or at a dark place such as under a table.

The traveling system unit 40 comprises motor drivers 41R, 41L; drive wheel motors 42R, 42L; and a gear unit (not shown) and drive wheels, both of which are driven by the drive wheel motors 42R, 42L. The drive wheel is disposed at the right and left side of the body, one at each side, and a free-rotating wheel without a driving source is disposed at the front center of the bottom of the body. The rotation direction and rotation angle of the drive wheel motors 42R, 42L can be finely regulated by the motor drivers 41R, 41L respectively and each of the motor drivers 41R, 41L outputs a corresponding drive signal according to a control command from the CPU 11. Furthermore, the rotation direction and rotation angle of actual drive wheels can be precisely detected based on the output from a rotary encoder that is mounted integrally with the drive motors 42R, 42L. Also, it is possible to dispose free-rotating driven wheels near the drive wheels, instead of directly coupling the rotary encoder to the drive wheels, and feed back the amount of rotation of said driven wheels. This enables actual amount of the drive wheels to be detected even when the drive wheels are skidding. The traveling system unit 40 further comprises a geomagnetic sensor 43 that enables traveling direction to be determined against geomagnetism. An acceleration sensor 44 detects accelerations in three axis (X, Y, Z) directions and outputs detection results.

Various types of gear unit and drive wheels can be adopted, including drive wheel made of a circular rubber tire and an endless belt.

This cleaning mechanism of this self-propelled cleaner comprises side brushes disposed at both sides of the front of the cleaner that sweeps together dust and the like existing on the floor around both sides of the body, a main brush that scoops up the dust collected around the center of the body, and a suction fan that sucks in the dust swept together by said main brush at around the center of the body and feed it to a dust box. The cleaning system unit 50 comprises side brush motors 51R, 51L and a main brush motor 52 to drive corresponding brushes; motor drivers 53R, 53L, 54 that supply drive current to the respective brush motors; a suction motor 55 to drive the suction fan.; and a motor driver 56 that supplies current to said suction motor. During a cleaning, the side brushes and a main brush are controlled by the CPU 11 based on floor condition, condition of the battery, instruction of the user, etc.

The camera system unit 60 is equipped with two CMOS cameras 61, 62 with different visual field angles, which are disposed at the front of the body and set to different elevation angles. The camera system unit further comprises a camera communication I/O 63 that instructs each of the cameras 61, 62 to take an image of a floor ahead and outputs the taken image; an illumination LED for a camera 64 consisting of 15 white LEDs directed to an image to be taken by the cameras 61, 62; and an LED driver 65 to supply drive current to said LED for illumination.

The wireless LAN unit 70 is equipped with a wireless LAN module 71 and the CPU 11 can be wirelessly connected to an external LAN according to a predetermined protocol. The wireless LAN module 71 assumes the provision of access points (not shown), which allow for connection to external wide area networks, such as the Internet, via routers or the like. This provides for sending and receiving of mails, browsing of WEB sites, etc. The wireless module 71 comprises a standardized card slot, a standardized wireless LAN card to be connected to said card slot, and the like. Needless to say, other standardized cards can also be connected to the card slot.

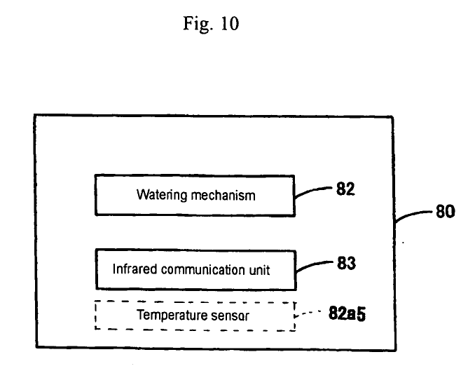

The optional unit 80 comprises additional sensors, etc. as shown in FIG. 10. In this embodiment, the optional unit 80 is equipped with a watering mechanism 82 and an infrared communication unit 83. The infrared communication unit 83 is capable of receiving an infrared signal containing coded positional information to be sent from a marker described below and of outputting the decoded positional information.

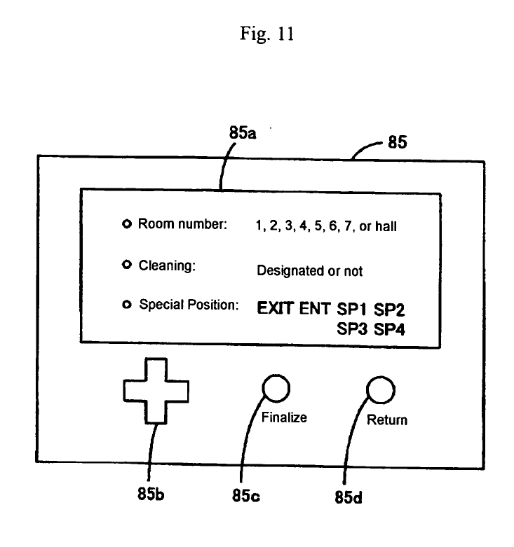

FIG. 11 shows an external appearance of said marker 85, on which an LED display 85a, a cross key 85b, a Finalizing key 85c, and a Return key 85d are provided. Inside the marker, a single-chip microcomputer, an infrared communication unit, a battery, etc. are provided. The single-chip microcomputer is capable of controlling the display on the LED display panel 85a according to the operations of the Finalizing key 85c and Return key 85d, generating setting parameters according to said operations, and outputting positional information according to said setting parameters from said infrared communication unit. In this embodiment, it is possible to set Room number: “1 to 7 and hall”, Whether or not to clean: “Yes” “No”, and Special position: “EXIT(exit)”, “ENT(entrance)”, “SP1(special position 1)”, “SP2 (special position 2)”, “SP3(special position 3)”, “SP4 (special position 4). In the following embodiment, the special position 1 represents the position of a first potted plant, the special position 2 a second potted plant, the special position 3 a third potted plant , and the special position 4 a fourth potted plant. A flowchart required for these settings is not a special one but can be prepared by one skilled in the art with ordinary knowledge.

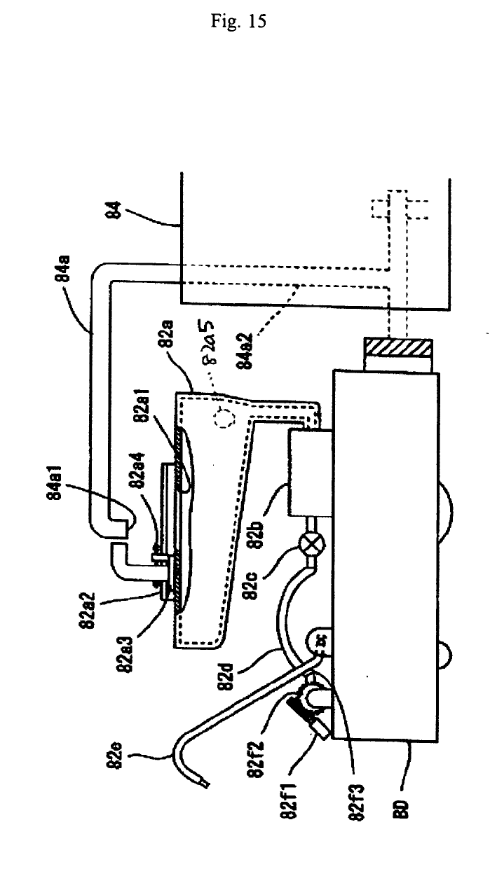

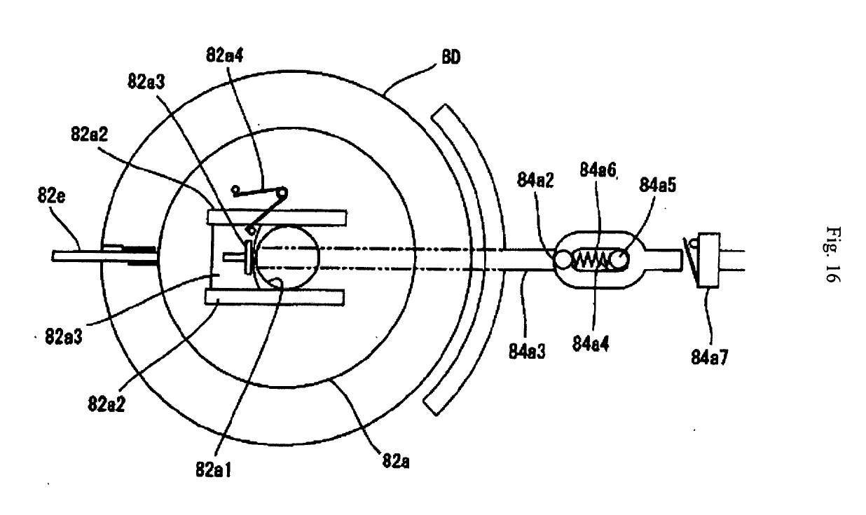

The watering mechanism 82 is a mechanism for watering potted plants and its basic construction is shown in FIGS. 15 and 16.

In the upper part of said watering mechanism, a water supply tank 82a is held by means of a stay (not shown) and a pressure pump 82b is connected to a lower opening on said water supply tank 82a. To the outlet of said pressure pump, a magnetic pump 82c is connected and a watering tube 82d with elasticity is connected to the outlet of the magnetic pump 82c. Said watering tube 82d passes through a reverse-J shaped hollow watering pipe 82e.

The water supply tank 82a has a circular opening 82a1 on its top, on both sides of which a pair of reverse-L shaped rails 82a2, 82a2 are formed in parallel to each other with the upper ends facing inside. Between the rails 82a2, 82a2 are held a slidable lid 82a3, which is normally energized by a spring 82a4 to cover said opening 82a, but uncovers said opening 82a1 by sliding itself against the force of said spring 82a4 when a projection 82a5 formed on the top of the lid 82a3 hits a water supply nozzle described below.

The pressure pump 82b is for pressurizing water supplied from the water supply tank 82a and is activated by a command from the CPU 11. The magnetic valve 82c is for controlling the opening and closing of the valve by means of an electric signal and opens or closes according to a command from the CPU 11.

The watering pipe 82e rotatably supported in vertical direction at one end with a bracket provided on the top of the body and an end of said watering tube 82d is exposed at the other end of the pipe. This watering pipe 82c and the watering tube 82d make up the watering nozzle. At a point nearer to the end than the turning fulcrum of the watering nozzle, a lift mechanism 82f is disposed. The lift mechanism 82f comprises a drive motor 82f1 equipped with a worm gear on its rotating shaft; a rotation gear 82f2 disposed parallel to vertical direction and engaged with said worm gear; and a lever 82f3 that is fixed to the rotating shaft of said rotation gear 82f2 and rotates along with said rotation gear within a predetermined angle range. When the drive motor 82f1 rotates, the rotation gear 82f2 engaged with the worm gear rotates along the rotating shaft, thus causing the end of the lever 82f3 to move up and down. The lever 82f3 is now supporting the watering nozzle from below and the other end of the watering nozzle moves up and down to a large extent. Said drive motor 82f1 rotates in a predetermine direction according to a command from the CPU 11.

In conjunction with this watering mechanism, there is provided a watering supply station 84. The water supply station 84 has a replenishment tank and a replenishment pump, by means of which water is supplied to said water supply tank 82a1 through the end of the water supply nozzle 84a. The water supply nozzle 84a projects horizontally beyond the top of the body 84b up to the height where it hits said projection 82a3 and there is an downward opening 84a1 at the end. The water supply nozzle 84a is supported at the base in a horizontally rotatable manner and has a projecting portion 84a3 which projects from the bottom of the rotation shaft 84a2 in the same direction as the top. The end of the projecting portion 84a3 is concaved so that the end can closely contact the outer surface of the body of said self-propelled cleaner. When the body approaches the water supply station 84, the body first hits this projecting portion 84a3, which is then displaced appropriately to closely contact the body. That is, the rotation shaft 84a has an elongated hole 84a4 at the bottom and a support pin 84a5 is inserted in the hole. This allows a slightly free movement of the rotation shaft and therefore even if the body is somewhat displaced, the body moves by itself to closely contact the projecting portion so that the projecting portion 84a3 and the body are aligned for close contact. Furthermore, a spring 84a6 is disposed inside the elongated hole 84a4 so as to energize the support pin 84a5 inward, and the projecting portion 84a3 is normally projecting outward to the fullest, thus leaving room for being pushed into the body. Pushing the projecting portion 84a3 into the body will displace a micro switch 84a7 to cause a “positioning completed” status to be signaled to a conducting circuit (not shown), which in turn activates the replenishment pump to discharge water contained in the replenishment tank from the opening 84a1 at the end of the water supply nozzle 84a.

At the time the body and the projecting portion 84a3 contact with each other, the end of the water supply nozzle 84a hits the projection 82a3 located at the top of the lid 82a2, thereby causing the lid 82a3 to slide to uncover the opening 82a1. Therefore, the water discharged from the opening 84a1 of the water supply nozzle 84a is re-supplied to the water supply tank 82a.

Next, the operation of the self-propelled cleaner constructed as above will be described.

(1) Traveling Control and Cleaning Operation

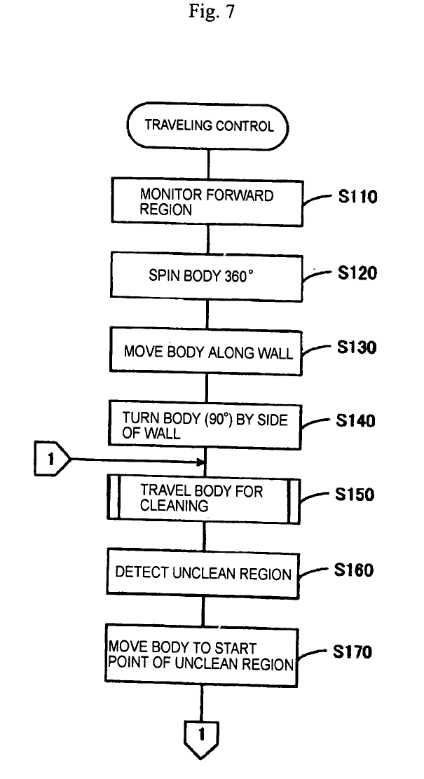

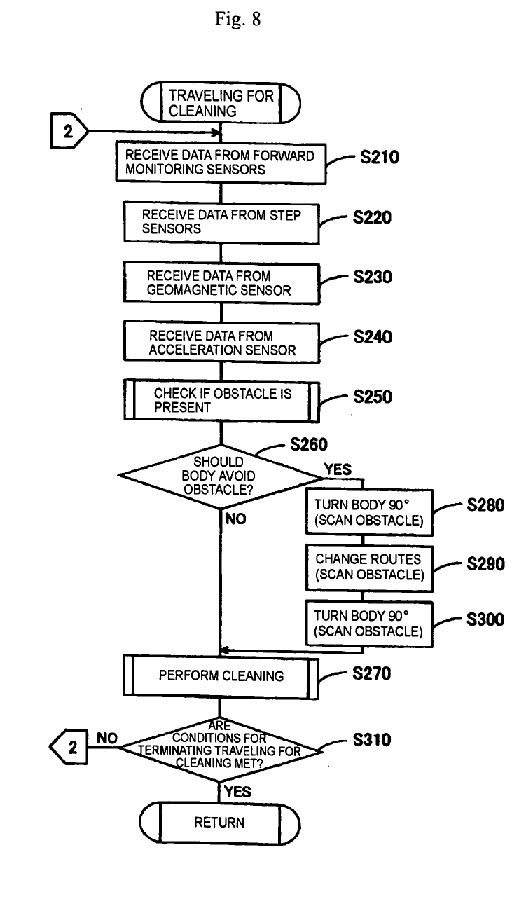

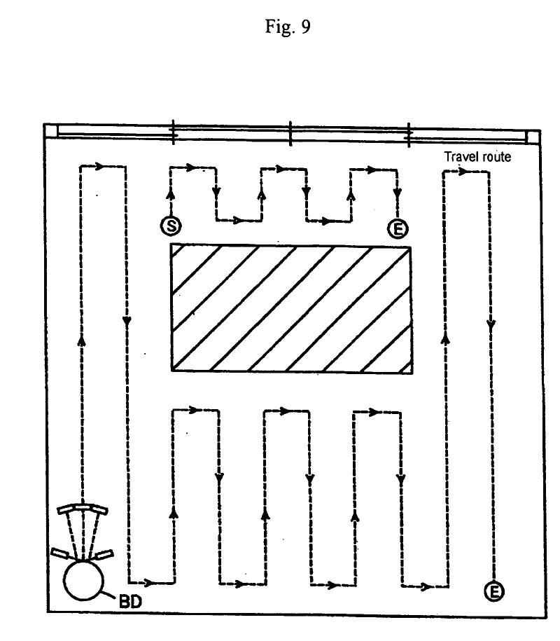

FIG. 7 and FIG. 8 show flowcharts corresponding to the control programs said CPU 11 executes and FIG. 9 shows a route along which a the self-propelled cleaner travels according to said control programs.

When the power is turned on, the CPU 11 starts to the traveling control shown in FIG. 7. In Step S110, detection results of the passive sensor for AF 31 are input to monitor a forward region. The detection results of the passive sensors for AF 31FR, 31FM, 31FL are used for monitoring a forward region. If the region is flat, the distance to an obliquely downward floor, Ll, as shown in FIG. 4 can be obtained from an image taken by these passive sensors for AF. Based on the detection results of the individual passive sensors for AF 31FR, 31FM, 31FL, it can be determined whether or not the front floor as wide as the body is flat. At this point, however, no information has been obtained about an area from the position immediately before the body to the position each of the passive sensors for AF 31FR, 31FM, 31FL is facing, and consequently that area becomes a blind spot.

In Step S120, the CPU 11 commands the motor drivers 41R, 41L to drive the drive wheel motors 42R, 42L respectively so that rotational direction is different from each other but amount of rotation is the same. This causes the body to start turning at the same position. Since the amount of rotation of the drive motors 42R, 42L required for a 360 spin turn at the same position is already known, the CPU 11 commands the motor drivers 41R, 41L to give the drive wheel motors that amount of rotation.

During a spin turn, the CPU 11 inputs detection results of the passive sensors for AF 31R, 31L to determine the situation of the position immediately before the body. The detection results during this period almost eliminate said blind spot and thus an existence of a flat floor around the body can be detected if there is no step or obstacle.

In Step S130, the CPU 11 commands the motor drivers 41R, 41L to give same amount of rotation to the drive wheel motors 42R, 42L respectively. This causes the body to start moving strait. During moving straight, the CPU 11 inputs detection results of the passive sensors for AF 31FR, 31FM, 31FL to move the cleaner ahead while determining whether or not any obstacle exists ahead. If a wall, i.e., an obstacle, can be detected ahead from said detection results, the cleaner stops at a predetermined distance before the wall.

In Step S140, the cleaner turns to the right 90 degrees. The cleaner stops at a predetermined distance before the wall in Step S130. This predetermine distance is a distance within which the body can turn without colliding against the wall and also the passive sensors for AF 31R, 31L can detect an obstacle to determine the situation immediately before and on the right and left sides. That is, in Step S130 the cleaner stops based on detection results of the passive sensors for AF 31FR, 31FM, 31FL, and when turning 90 degrees in Step S140, the cleaner stops at a distance within which at least the passive sensor for AF 31L can detect the position of a wall. When turning 90 degrees, the situation of the position immediately ahead of the cleaner is determined beforehand based on detection results of said passive sensors for AF 31R, 31L. FIG. 9 shows a situation where a cleaning is started at the lower left corner of a room (cleaning start position) as viewed from the top, where the cleaner thus reached.

There are various methods for the cleaner to reach a cleaning start position other than the method mentioned above. For example, since simply turning right 90 degrees when the cleaner reaches a wall, a cleaning will be started at the middle of the first wall. In order to reach the optimum start position at the lower left corner of a room as shown in FIG. 9, it is desirable for the cleaner to turn left 90 degrees when it comes up against a wall, move forward to the front wall, and turn 180 degrees when the cleaner reaches the wall.

In Step S150, a cleaning travel is performed. FIG. 8 shows a more detailed flow of said cleaning travel. Before traveling forward, detection results of various sensors are input in steps S210 to S240. Step S210 inputs data from forward monitoring sensors, specifically detection results of the passive sensors for AF 31FR, 31FM, 31FL, 31CL, which is used to determine whether or not an obstacle of wall exists ahead of the traveling range. The forward monitoring includes a ceiling in a broad sense.

Step S220 inputs data from step sensors, specifically detection results of the passive sensors for AF 31R, 31L, which is used to determine whether or not a step exists immediately before the traveling range. When traveling along a wall or obstacle in parallel, a distance to the wall or obstacle is measured and data thus obtained is used to determine whether or not the cleaner is moving in parallel to the wall or obstacle.

Step S230 inputs data from a geomagnetic sensor, specifically the geomagnetic sensor 43, which is used to determine whether or not travel direction varies during a forward travel. For example, an angle of geomagnetism at the start of a cleaning travel is stored in memory and if an angle detected during traveling differs from the stored angle, then the travel direction is corrected back to the original angle by slightly changing the amount of rotation of either left or right drive wheel motors of 42R, 42L. For example, if travel direction changed toward an angle-increasing direction (except for a change from 359 degree to 0 degree), it is necessary to correct the pass toward left direction by issuing a drive control command to the motor driver 41R, 41L to increase the amount of rotation of the right drive wheel motor 42R slightly more than that of the left drive wheel motor 42L.

Step S240 inputs data from an acceleration sensor, specifically detection results of the acceleration sensor 44, which is used to check for travel condition. For example, if an acceleration toward a roughly constant direction can be detected at the start of a forward travel, it is determined that the cleaner is traveling normally. However, if a rotating acceleration is detected, it is determined that either drive wheel motor is not driven. Also, if an acceleration exceeding a normal range of vales is detected, it is determined that the cleaner fell from a step or overturned. If a large backward acceleration is detected during a forward travel, it is determined that the cleaner hit an obstacle located ahead. Although direct control of the travel, such as maintaining a target acceleration by inputting an acceleration value or determining the speed of the cleaner based on the integral value as mentioned above, is not performed, acceleration values are effectively used to detect abnormalities.

Step S250 determines whether an obstacle exists based on detection results of the passive sensors for AF 31FR, 31FM, 31CL, 31FL, 31R, 31L that have been input in steps S210 and S220. The determination of an obstacle is made for the front, ceiling, and position immediately ahead. The front means an obstacle or wall, the position immediately ahead means a step as well as situations on the right and left sides beyond the traveling range, such as existence of a wall. The ceiling is used to identify an exit of the room without a door by detecting a head jamb or the like.

Step S260 determines whether or not the cleaner need to get around based on detection results of each sensor. If the cleaner need not to get around, a cleaning process in Step S270 is performed. The cleaning process is a process of sucking in dust on a floor while rotating the side brush and the main brush, specifically, issuing a command to drive the motor drivers 53R, 53L, 54, 56 to drive motors 51R, 51L, 52, 55 respectively. Needless to say, said command is issued at all times during a travel and is stopped when a terminating condition described below is satisfied.

In contrast, if it is determined that getting around is necessary, the cleaner turns right 90 degrees in Step S280. This turn is a 90 degree turn at the same position and is caused by instructing the motor drivers 41R, 41L to rotate the drive wheel motors 42R, 42L in different direction from each other and give a driving force to provide the amount of rotation required for a 90 degree turn. The right drive wheel is rotated backward and the left drive wheel is rotated forward. While the wheels is turning, detection results of step sensors, specifically the passive sensors for AF 31R, 31L, are input to determine whether or not an obstacle exist. For example, when an obstacle is detected in front and the cleaner is turned right 90 degrees, if the passive sensor for AF 31R does not detect a wall immediately ahead on the right, it may be determined that the cleaner comes near the front wall. However, if the passive sensor detects a wall immediately ahead on the right even after the turning, it may be determined that the cleaner is at a corner. If neither of the passive sensors for AF 31R, 31L detects an obstacle immediately ahead, it may be determined that the cleaner comes near not a wall but a small obstacle.

In Step S290, the cleaner travels forward to change the travel route while scanning obstacles. When the cleaner comes near a wall, it turns right 90 degrees and moves forward. If the cleaner stops just before the wall, the forward travel distance is about the width of the body. After moving forward by that distance, the cleaner performs a 90 degree right turn again in Step S300.

During this traveling, scanning of obstacles on front and on front right and left sides is performed at all times to identify the situation and the information thus obtained is stored in memory.

Meanwhile, a 90 degree right turn is made twice in the above description and therefore if a 90 degree right turn is made when another wall is detected in front, the cleaner returns to the original place. To prevent this, the 90 degree turn is to be performed alternately between right and left directions, such as, if the first turn is to the right, the second is to the left, the third is to the right and so on. Accordingly, odd time turns become right turn and even time turns become left turns.

Thus, the cleaner travels in a zigzag in the room while scanning obstacles and getting around them. Step S310 determines whether or not the cleaner arrived at the terminal position. A cleaning travel terminates either when the cleaner traveled along the wall after the second turn and then detected an obstacle or when the cleaner moved into an already traveled area. That is, the former is a terminating condition that occurs after the last end-to-end zigzag travel and the latter is a terminating condition that occurs when a cleaning travel is started again upon discovery of a not yet cleaned area as described below.

If neither of these terminating conditions is satisfied, a cleaning travel is repeated from Step S210. If either terminating condition is satisfied, the subroutine for this cleaning travel is terminated and control returns to the process shown in FIG. 7.

After returning to the process, Step S160 determines whether there is any area not yet cleaned based on the previous travel route and situations around the travel route. If a not-yet cleaned area is found, the cleaner moves to the start point at the not-yet cleaned area to resume a cleaning travel from Step S150.

Even if several not-yet cleaned areas around the floor is left, it is possible to eliminate those areas eventually by repeating the detection of a not-yet cleaned area whenever the cleaning travel terminating condition mentioned above is satisfied.

(2) Mapping

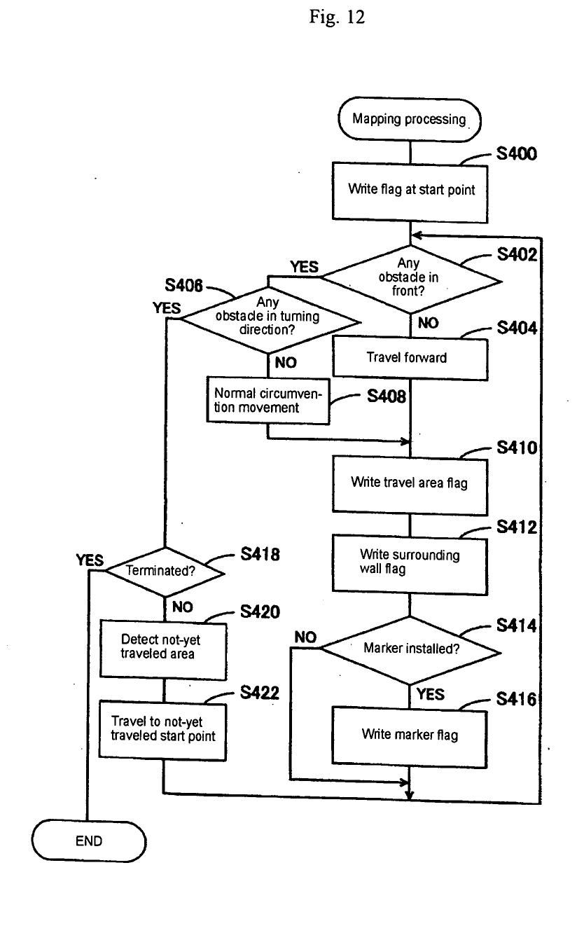

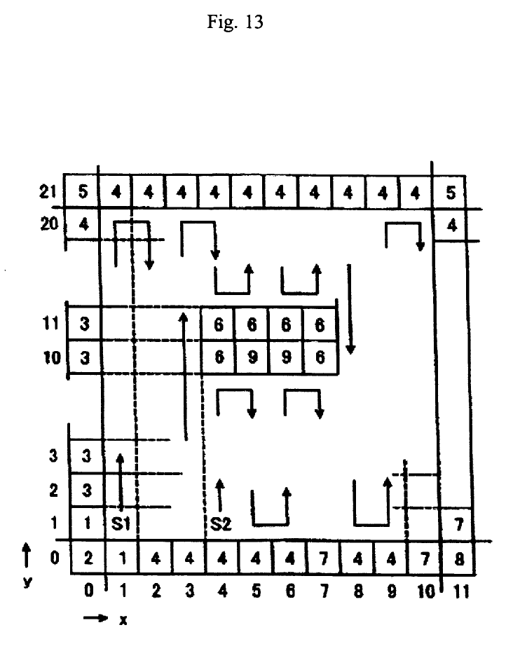

Although not-yet cleaned areas can be identified by various methods, embodied here is the mapping method shown in FIG. 12 and FIG. 13.

FIG. 12 shows a flowchart of the mapping and FIG. 13 is a diagram illustrating the mapping method. In this example, a travel route and walls detected during a travel are written on the map reserved in memory area, based on detection results of said rotary encoder, and it is determined whether or not surrounding walls are continuous, surrounding areas of detected obstacles are also continuous, and the cleaning travel covered all the areas excluding the obstacles.

A mapping database is a two-dimensional database addressable with X and Y axes, the (1, 1) being the start point and the (n, 0) (0m m) representing provisional walls. The room is mapped by marking off not-yet traveled area, cleaning-completed area, wall, and obstacle using the size of the body (30 cm×30 cm) as unit area.

Step S400 writes a flag of the start point. As shown in FIG. 13, the start point (1, 1) is a corner of the room. The cleaner makes a 360 degree spin turn to ensure that walls exist back and left, (1) wall flags are written at respective unit areas (1, 0), (0,1), and (2) a wall flag is also written at the intersection (0, 0). Step S402 determines whether any obstacle exists ahead of the body and if there is no obstacle, the cleaner travels forward by unit area in Step S404. This forward travel is actually a cleaning travel mentioned above, specifically, when the cleaner has traveled by unit area during a cleaning travel, which is determined based on the output from the rotary encoder, the mapping processing is synchronized with the travel of the cleaner and continues in parallel with the travel.

In contrast, if an obstacle is identified ahead of the cleaner, it is determined whether or not an obstacle exists in the turning direction in Step S406. An obstacle is circumvented by turning 90 degrees, traveling forward, and turning 90 degrees again and the turning direction is changed by repeating a left turn and a right turn twice respectively. For example, if a next turn for circumvention is to the right, when an obstacle exists in front, it will be determined whether or not it is possible to travel in the right direction and turn. Initially, it is determined that the area in the right direction is a not-yet cleaned area and no obstacle exists in the turning direction, and as a result an ordinary circumvention movement is made in Step S408.

After these movements, Step S410 writes a travel area flag to a unit area of the travel route. Since having traveled means having cleaned a flag indicating the cleaning-finished area is written on the map. Step S412 writes the situations of surrounding walls as surrounding wall flag for each unit area. When the cleaner moved from the unit area (1, 1) to (1, 2), it is possible to determine whether or not the unit areas (0, 1), (2, 1) are walls, based on detection results of the passive sensors for AF 31R, 31L. A flag indicating a wall can be written for the unit area (0, 1) and a flag indicating a not-yet traveled and not-yet cleaned area can be written for the unit area (2, 1).

Meanwhile, in the unit area (1, 20), an obstacle is detected in front and therefore the cleaner reversed the traveling direction 180 degrees by making a 90 degree turn twice and by traveling forward while traveling to the unit area (2, 20). At this time, a flag can be written for each of the unit areas (0, 20), (2, 20), (1, 21), (2, 21)—(4). For the unit area (0, 21), a flag indicating a wall is written based on the judgment that this unit area is an intersection between walls—(5). An already traveled and cleaned area is also treated as an obstacle.

When the cleaner travels forward, an obstacle is detected in the right direction at the unit areas (3, 10) and (3, 11), and an obstacle flag is written at this point—(6). During a travel at unit areas (3, 1) through (3, 9), a not-yet traveled and not-yet cleaned area is detected on the right side of the traveling direction and a flag indicating this area is written. Likewise, when the cleaner travels at unit areas (8, 9) through (8, 1), a not-yet traveled and not-yet cleaned area is detected on the right side of the traveling direction and a flag indicating this area.

In the unit area (4, 12), an obstacle is detected in front and a circumvention movement is made. At this time, however, an obstacle flag has been written to the unit area (4, 11) and therefore an obstacle flag is written to the unit area (4, 11) as the cleaner travels.

Step S414 determines whether or not a communication was made with said marker 85 to obtain positional information at a unit area through which the cleaner traveled, and if a communication was made then a flag based on the information obtained from the marker is written in Step S4116. For example, if the user has placed the cleaner at a particular unit area to specify an emergency exit by operating the operation keys 85b to 85d of the marker 85, the cleaner will obtain said positional information by means of the infrared communication unit 83 when the body passes said unit area and writes a flag indicating an emergency exit.

The cleaner repeats a forward travel and a circumvention movement and detects an obstacle at the unit area (10, 20) on the left side of traveling direction. In this case, since the unit area (10, 21) has been identified as a continuous wall, a flag indicating a wall is written for the unit area (11, 20)—(4), and then a wall flag is also written for the intersection (11, 21)—(5).

As a result of repeating a forward travel and a circumvention movement, the cleaner detects an object in front at unit areas (10, 1) and it is determined that another obstacle exists in a turning direction. In this case, therefore, Step S418 determines whether or not this obstacle is the terminating point. For the unit area (10, 1), an obstacle in front and a wall on the left side of the traveling direction are detected—(7), (8).

Whether or not said unit area is the terminating point is determined first by determining whether or not a unit area to which a not-yet traveled and not-yet cleaned flag is written exists. If there are no more unit areas detected to which a not-yet traveled and not-yet cleaned flag is written, it is determined whether or not the wall flag written at the start point is surrounding the room continuously. If this flag is surrounding the room, any area to which a flag has not been written is searched for by scanning the room in X and Y directions An area identified as an obstacle is also identified as a continuous area just like a wall, which completes the detection of obstacles.

If said unit area is not the terminating point, the cleaner detects a not-yet traveled area in Step S420, moves to the start point at the not-yet traveled area, and repeats the processing mentioned above. If the terminating point is eventually identified, the mapping processing is completed. At the completion of the mapping, the walls and travel areas in the room are obvious at a glance. This map is used as geographical information on each room.

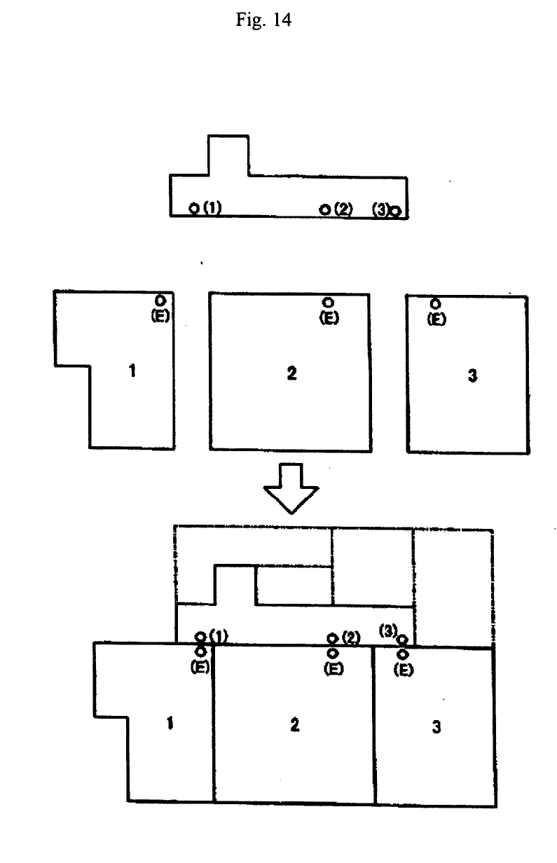

The mapping processing mentioned above is completed for all rooms and a hall, and for the hall, the entrance to each room is designated by means of the marker 85. FIG. 14 shows a method of linking together the geographical information generated for each room and a hall. By designating the room number (1 to 3) and exit (E) of each room, the entrance (1 to 3) to each room, etc., the geographical information obtained for each room can be linked together two-dimensionally.

(3) Watering Control Processing

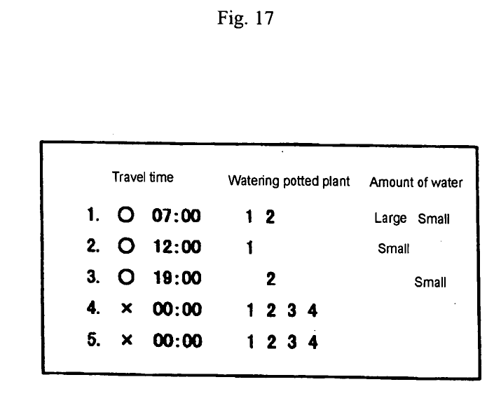

FIG. 17 shows a setting screen to set watering times and positions.

Watering travel times, potted plants to be watered for each watering, and amount of water (“large” or “small”) to be poured on each potted plant are specified by operating the operation switch 15a and the LED display panel 15b. Up to five watering travel times can be set and up to four potted plant locations can be set by means of the special positions SP1 to SP4 of the marker 85. A mark (o or x) put before each watering travel time designates whether or not each watering travel to be performed. Under the amount of water column, amount of water to be poured on each of the potted plants 1 to 4 is shown with “large” or “small”. In the example, in FIG. 17, the cleaner travels to the first and second potted plants to water at 07:00, and pours a “large” amount of water on the first pot and a “small” amount of water on the second pot. The cleaner travels to the first pot at 12:00 to pour a small amount of water and to the second pot at 19:00 to pour a small amount of water. Needless to say, the setting screen contains a clock required for setting the watering travel time.

A program for setting the watering travel times and potted plants to be watered is executed according to the a flowchart that can be written by one skilled in the art with ordinary knowledge.

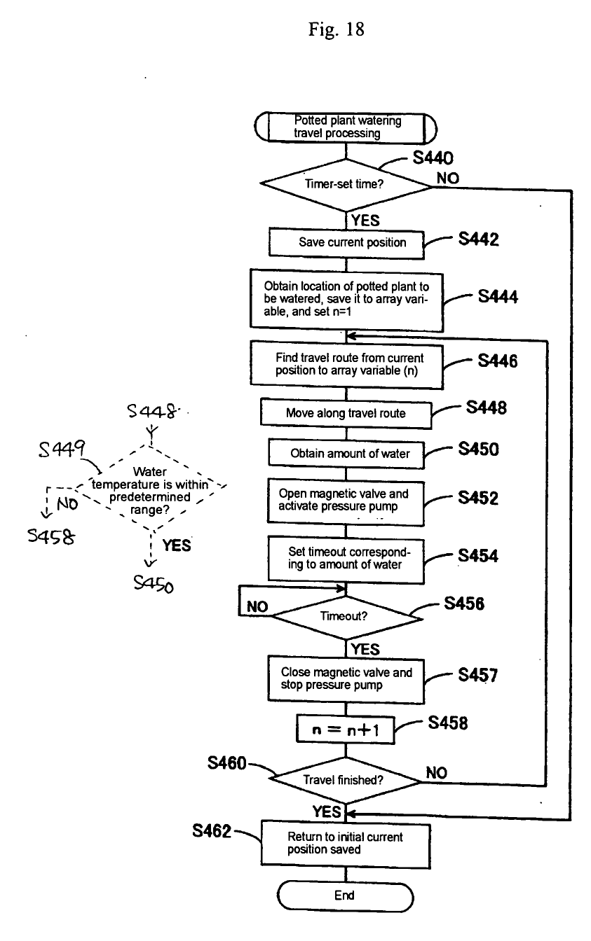

FIG. 18 shows a flowchart of the process of traveling to a potted plant and watering it.

When the user instructs the execution of this process through the operation panel unit 15, it is determined whether or not current time is the time set by the timer by comparing both times in Step S440, and if current time is the timer-set time, the following processing is executed.

Step S442 saves a current position of the cleaner. By saving the current position at this point, the cleaner can return to this position after traveling to the last potted plant.

Step S444 obtains locations of potted plants to which the cleaner travels for watering and saves the obtained locations to an array variable. If current time is 07:00, potted plants to be watered are the first and second ones as shown in FIG. 17. Therefore, the positions of the two pots are obtained and saved to the array variable. Saving the locations of pots to the array variable allows the cleaner to travel sequentially by means of a variable n. Accordingly, a “1” is set to the variable n.

Step S446 finds a travel route to the location of the nth potted plant saved in the array variable from current position.

As mentioned above, if the geographical information is available, it is possible to search a travel route from current location to the location of the nth potted plant. The well known method of finding a route to the exit of a maze can be employed for this purpose. For example, if you move along a maze from its entrance with your right hand always touching the wall according to this method or the like, you can reach the goal eventually. Then, erase redundant routes, for example a turned around route, one by one. In the case of the cleaner moving inside a room, find a location where the cleaner made a horseshoe-shaped turn and shift such a location away from the wall to shorten the route unless there is an obstacle. Needless to say, it is also possible to provide an interface to give a travel route to the user instead of automatically finding one as described above.

After a travel route from current position to the position of a potted plant is found in this way, the cleaner moves along said travel route in Step S448. During the travel, the CPU 11 commands the drive motor 82f1 to turn the cleaner in a predetermined direction and raise the lever 82f3. When the travel is completed, the CPU 11 commands the drive motor 82f1 to turn the cleaner in the opposite direction and lower the lever 82f3. The cleaner is now located immediately before the potted plant and the end of the watering nozzle gradually lowers from its highest position by lowering the lever 82f3 and stops when end of the nozzle touches the surface of the soil of the pot. It is acceptable that the end of the nozzle stops when it touches the plant in the pot.

Step S450 obtains the amount of water to be poured on the potted plant. The same processing as for saving the location of a potted plant to the array variable can be used for obtaining the amount of water, that is, the amount of water (“large” or “small”) for the nth potted plant can be obtained by referencing the array variable.

In Step S452, in order to start watering, a control signal is sent to the magnetic valve 82c to open the valve and also to activate the pressure pump 82b, which starts the watering.

In Step S454, a timeout period corresponding to the amount of water previously obtained is set and in step 456, it is determined whether or not a timeout occurred. If a timeout occurs, a control signal is sent to the magnetic valve 82c to close the same and also the pressure pump 82b is stopped in Step S457.

Since the water is pressurized to a constant pressure by the pressure pump 82b, the amount of water is in proportion to the time during which the magnetic valve is opened. This open time has been set as a timeout in Step S454 and therefore the amount of water specified by the setting screen as shown in FIG. 17 can be discharged.

On completion of watering for one potted plant, the variable n is incremented in Step S458 and it is determined from a value of said variable whether or not the watering travel is finished, in Step S460. That is, if said value is larger than the number of locations of potted plants obtained in Step S444, the watering travel is finished and in Step S462 the cleaner returns to the initial current position saved in Step S442. Otherwise, return to Step S446 and find a travel route from current position at this point to the location of the next potted plant.

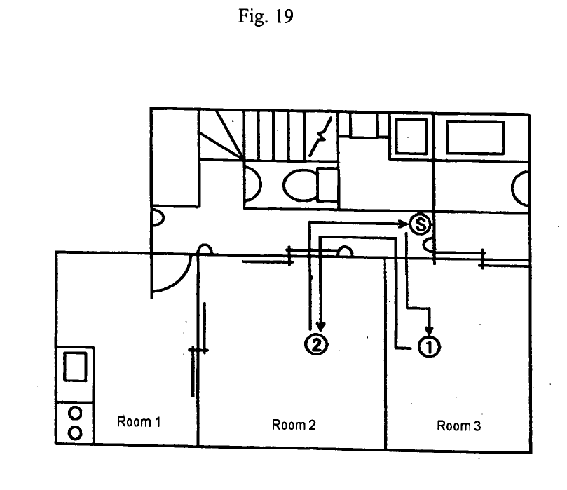

FIG. 19 shows a watering travel route for the case where the location of a first potted plant is set in room 3, the location of a second potted plant in room 2, and the body is normally standing by at the hall.

As mentioned above, when current time is determined to be the time set by the timer in Step S440, a travel route from the standby position to the location of the first potted plant is found in Step S446 and then the cleaner is moved to said location and then the specified amount of water is discharged in step 448 (steps S450 to S458). On completion of the watering, a travel route from the location of the first potted plant to that of the second potted plant is found in Step S446 and then the cleaner is moved to said location and the specified amount of water is discharged in Step S448 (steps S450 to S458).

When watering is finished at the location of the second potted plant, the cleaner returns to the standby position at the hall in Step S462.

In addition to the control mentioned above, it is also possible to determine whether or not watering should be done by detecting a water temperature. Specifically, if the water supply tank is too much exposed to the sun, the water in the tank is warmed and pouring that warmed water will damage the root of the plant. The root of a plant is also damaged if the water in the tank is too cooled in a cold day. To prevent this, a water temperature is detected before watering and if the temperature is within a predetermined range, watering is done.

To detect a water temperature, the water supply tank 82a is equipped with a temperature sensor 82a as shown in FIGS. 10 and 15 and the CPU 11 in the control unit 10 obtains the output from said temperature sensor 82a5 to detect the water temperature.

In the potted plant watering travel processing, the CPU 11 detect the water temperature based on the output from the temperature sensor 82a5 after Step S448 as shown with a dotted line in FIG. 18, and if the temperature is within a predetermined range (for example, 5° C. to 40° C.) that will not damage the root of a plant watering is done in Step S450 and after. Otherwise, the cleaner moves to the next potted plant without watering.

In this example, a water temperature is detected for each potted plant to allow watering as many potted plants as possible. However, it is also possible to detect a water temperature when current time is determined to be the time set by the timer in Step S440 and, unless the detected temperature is within a predetermined range, finish the processing without watering for that time and stand by until the next timer-set time.

Thus, effective use of the self-propelling capability according to this invention enables the watering travel to the locations of designated potted plants.

1. A self-propelled cleaner having a body equipped with a cleaning mechanism and a drive mechanism having a plurality of drive wheels disposed at left and right sides of said body and capable of being controlled to rotate individually so as to enable steering and driving said cleaner,
said cleaner comprising:
a mapping processor that obtains and stores in memory geographical information on a room to be cleaned while said cleaner is traveling in a room for cleaning and also obtains positional information on potted plant from a marker installed at a predetermined location in the room and outputting predetermined positional information, and then adds said positional information to said geographical information;
a watering mechanism that waters a potted plant located at a predetermined place and height and comprises
a reverse-J shaped watering nozzle capable of being vertically tilted at its base and
a lift mechanism capable of moving up and down that supports said watering nozzle from below at a point nearer to the end of said nozzle than a rotation fulcrum at the base of said nozzle, and moves up before watering and down to start watering, and is equipped with a pressure pump to pressurize discharging water to a predetermined pressure and a magnetic valve to control the amount of water by discharging the pressurized water for a predetermined duration, wherein the amount of discharging water can be adjusted by adjusting the time during which said magnetic valve is opened, a water supply tank with an opening and a lid on the top that opens said lid at a predetermine position of a water supply station and supplies water to said watering mechanism; and
a watering control processor capable of controlling, at a predetermined timing, said drive mechanism to travel the cleaner from current position to the location of a potted plant to be set in said geographical information and said watering mechanism to water at said location.

2. A self-propelled cleaner having a body equipped with a cleaning mechanism and a drive mechanism capable of steering and driving said cleaner, wherein said cleaner further comprising:
a mapping processor that stores in memory geographical information on a room to be cleaned;
a watering mechanism that water a potted plant located at a predetermined place and height; and
a watering control processor capable of controlling, at a predetermined timing, said drive mechanism to travel the cleaner from current position to the location of a potted plant to be set in said geographical information and said watering mechanism to water at said location.

3. A self-propelled cleaner of claim 2 wherein:
said mapping processor obtains positional information from a marker, which is installed at a predetermine location and outputs a predetermined said positional information, and add that information to said geographical information.

4. A self-propelled cleaner according to claim 2, wherein:
said watering mechanism further comprising
a reverse-J shaped watering nozzle capable of being tilted vertically at its base, and
a lift mechanism capable of moving up and down that supports said watering nozzle from below at a point nearer to the end of said watering nozzle than a rotation fulcrum at the base of said watering nozzle,
wherein
the lift mechanism moves up before watering and down to start watering.

5. A self-propelled cleaner according to claim 4, wherein:
said watering nozzle further comprises
a watering pipe that is rotatably supported in vertical direction by a bracket mounted on the top of the body at one end, with the end of a watering tube exposed at the other end;
said lift mechanism is disposed nearer to the end of said nozzle than the rotation fulcrum of said nozzle, and further comprises
a drive motor having a warm gear on a rotation shaft,
a rotation gear that is disposed in parallel to vertical direction and engages with said warm gear, and a
lever that fixed to said rotation gear and rotates with said rotation gear within a predetermined angle range.

6. A self-propelled cleaner according to claim 2, wherein:
said watering mechanism has a water supply tank with an opening and a lid on top and is used along with a predetermined water supply station;
said water supply station has a alignment mechanism with said body which enables said water supply nozzle to be aligned with the opening of said water supply tank; and
said watering mechanism receives water by opening said lid at the position of said water supply station.

7. A self-propelled cleaner according to claim 6, wherein:
said watering mechanism is equipped with a replenishment tank and a replenishment pump; and
water is supplied to said water supply tank through the end of said water supply nozzle.

8. A self-propelled cleaner according to claim 7, wherein:
said water supply station is equipped with a water supply nozzle projecting outward horizontally from the top of the body of said self-propelled cleaner, and having an downward opening at the end and a projecting portion that is supported in a horizontally rotatable manner at the base and projects from the lower end of its rotating shaft in the same manner and direction as the upper part;
said projecting portion is concaved at the end to allow a roughly close contact with the surface of said body and when said body approaches and first hits this projecting portion displaces appropriately to closely contact said body; and said rotation shaft has an elongated hole at the end in which a support is inserted to allow some free movements, and therefore even if said body is slightly misaligned with said projecting portion said body moves by itself to contact said projecting portion, whereby said body is aligned with said projecting portion to achieve a roughly close contact.

9. A self-propelled cleaner according to claim 8, wherein:
a spring is mounted inside said elongated hole to energize a support pin inward; and
said projecting portion is normally fully projecting outward to leave room for being pushed into the body and when said projecting portion is pushed into the body a micro switch is displaced to signal a completion of alignment, thereby activating said replenishment pump to discharge the water in said replenishment tank from the end of said water supply nozzle.

10. A self-propelled cleaner of claim 2, wherein:
said watering mechanism further comprises a pressure pump to pressurizes discharging water to a predetermined pressure and a magnetic valve to control the amount of water by discharging the pressurized water for a predetermined duration; and
the amount of discharging water can be adjustable by adjusting the time during which said magnetic valve is opened.

11. A self-propelled cleaner of claim 2, wherein:
said watering control processor determines whether or not the water temperature is within a predetermine temperature range and causes said watering to be done only when the water temperature is within the predetermined range.
